(19) United States
(12) Patent Application Publication
(10) Pub. No.: US 2011/0186204 A1
(43) Pub. Date: Aug. 4, 2011

(54) HEATING APPARATUS AND METHOD OF USE OF THE SAME IN A VIBRATION WELDING PROCESS

(75) Inventors: Wayne W. Cai, Troy, MI (US); Susan M. Smyth, Rochester Hills, MI (US); Paul F. Spacher, Rochester, NY (US); Edgar M. Storm, JR., Spencerport, NY (US); James G. Schroth, Troy, MI (US)

(73) Assignee: GM GLOBAL TECHNOLOGY OPERATIONS, INC., Detroit, MI (US)

(21) Appl. No.: 12/955,969

(22) Filed: Nov. 30, 2010

Related U.S. Application Data
(60) Provisional application No. 61/299,403, filed on Jan. 29, 2010.
(60) Provisional application No. 61/362,942, filed on Jul. 9, 2010.

(51) Int. Cl. H01M 10/04; B29C 65/02

(52) U.S. Cl. 156/73.1; 156/359

(57) ABSTRACT

A method for heating a work piece or a welding interface using a vibration welding system includes positioning the work piece adjacent to a welding tool to define the welding interface and then heating the work piece or the welding interface to within a calibrated threshold temperature using a thermal device, e.g., a heat rod, laser device, or blower. A high-frequency vibration may be applied to form a weld. The work piece may include an adjacent interconnecting member and battery tab. The thermal device may be embedded within the welding tool and controlled via a temperature controller. A vibration welding system includes a welding tool, a thermal device, and a controller. The controller controls the thermal device to thereby control the welding temperature at or along the welding interface. The thermal device may be embedded within the welding tool, which may be configured as an anvil body in one embodiment.

### CROSS REFERENCE TO RELATED APPLICATIONS

This application claims the benefit of U.S. Provisional Patent Application No. 61/299,403, filed Jan. 29, 2010, and U.S. Provisional Patent Application No. 61/362,942, filed Jul. 9, 2010, which are hereby incorporated by reference in their entireties.

### TECHNICAL FIELD

The present invention relates to a heating apparatus and method of use in a vibration welding process.

### BACKGROUND

The process of vibration welding applies controlled vibrations in a particular range of frequencies and directions to thereby join adjacent work piece surfaces. Ultrasonic welding and other vibration welding processes clamp the work piece(s) and transmit calibrated vibrations through the work piece. Surface friction is thus created along any interfacing surfaces. Heat generated from the surface friction softens the interfacing surfaces. The work piece is ultimately joined along the interfacing surfaces.

In a vibration welding system, a welding horn or sonotrode is directly connected to or formed integrally with one or more welding pads. The welding pads may include knurls or other textured surface patterns which physically contact the work piece. During the welding process, the work piece is positioned and clamped between an anvil and the welding pads of the sonotrode. The efficiency, consistency, and reliability/durability of a vibration-welded part, e.g., conductive tabs of a multi-cell vehicle battery, depend largely on the methodology and design of the welding tools used to form the various welds in the finished part.

### SUMMARY

Accordingly, a vibration welding method and system are provided herein for increasing a welding temperature during a vibration welding process by heating a selected welding interface and/or by heating a portion of a work piece positioned adjacent to the interface. The system increases the welding temperature using a thermal device, such as a laser or a heating rod. The thermal device heats the work piece prior to or concurrent with introducing vibrations to the work piece.

In a vibration welding system having a sonotrode/welding horn, welding pads, and a welding anvil, the temperature in the weld zone drops as heat energy from the vibrations of the sonotrode dissipates away from the welding interface. Even if equal amounts of heat can be generated at each of the different welding interfaces for a given multiple-sheet welding configuration, the welding temperature at each of the welding interfaces may differ drastically, e.g., due to different friction conditions, different relative motion between surfaces of a work piece, and heat sink effects.

Therefore, a designated portion of the system or the work piece itself, such as the thickest portion of the work piece or the surface or component of the work piece having the highest thermal conductivity, can be selectively heated as set forth herein using the thermal device. In one embodiment, the thermal device is embedded in the structure of the anvil to heat the welding interface or portion of the work piece closest to the anvil, while in another embodiment an external device such as a laser is used to direct energy at the interfacing surfaces of the work piece.

A method for heating a work piece and/or a welding interface during a vibration welding process includes positioning the work piece adjacent to a welding tool such that the welding interface is also adjacent to the welding tool. The method includes heating the work piece and/or the welding interface to within a calibrated threshold temperature using the thermal device noted above.

The method may be embodied in one manner as a two-step process, wherein a work piece is pre-heated in one step and welded in another step. This may allow for simultaneous pre-heating and welding of different work pieces, e.g., different portions of a battery pack in a vehicle. A heating apparatus, i.e., any suitable structure such as a block of metal containing the thermal device, and the welding apparatus may be placed on two separate station or robot axes and independently controlled. In another embodiment, the heating apparatus may be a resistance heating device and a pair of electrodes which directly generate heat via contact or bulk resistance. Heating temperatures are generally sufficient at the 100° C.-300° C. level, which may be achieved using the heating apparatus disclosed herein.

A vibration welding system for welding adjacent surfaces of a work piece using vibration includes a welding tool, a thermal device operable for heating a work piece or a welding interface defined by the adjacent surfaces of the work piece, and a controller. The controller controls an operation of the thermal device to thereby control the welding temperature to within a calibrated threshold temperature at a desired location, for example at or along a selected welding interface.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view illustration of a vibration welding system using a thermal device to heat a work piece and/or a welding interface as disclosed herein;

FIG. 2 is a partial cross-sectional side view illustration of an embedded thermal device and welding tool usable with the system shown in FIG. 1;

FIG. 3 is schematic perspective view illustration of a welding tool having an embedded heat rod according to one possible embodiment;

FIG. 4 is a flow chart describing a method for heating a welding interface during a vibration welding process using the welding system shown in FIG. 1;

FIG. 5 is a schematic illustration of a heating apparatus usable with the system shown in FIG. 1; and

FIG. 6 is a schematic illustration of another heating apparatus usable with the system shown in FIG. 1.

### DESCRIPTION

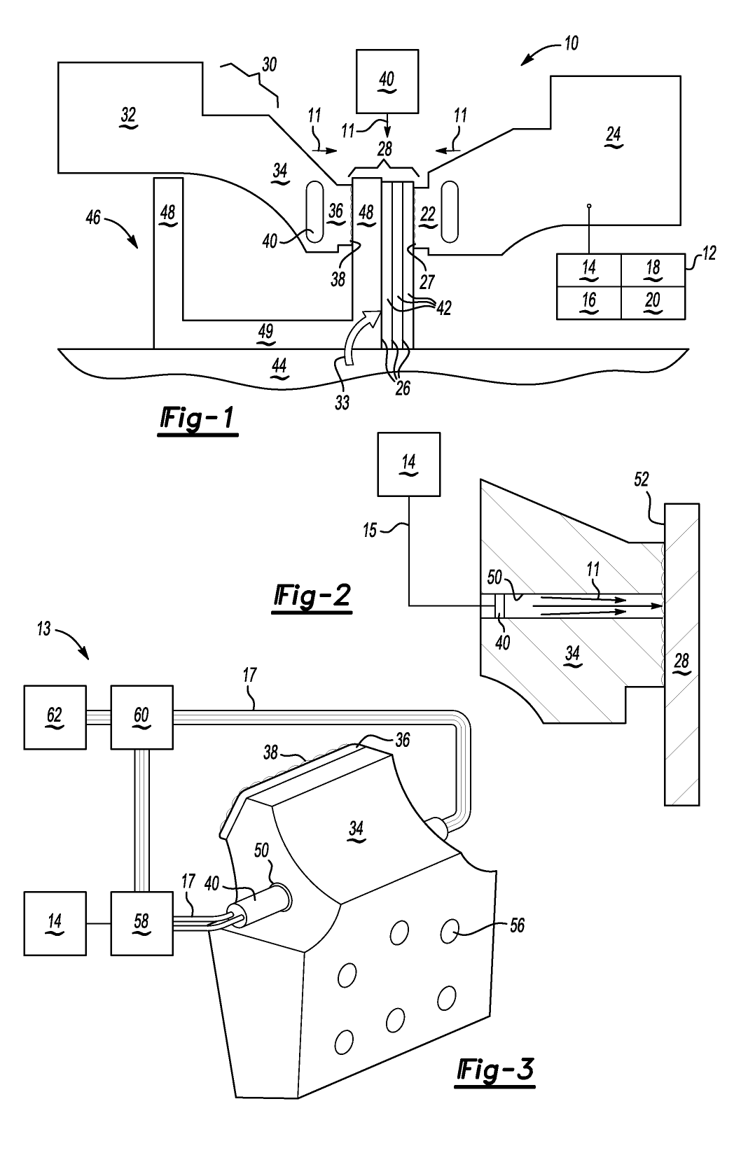

Referring to the drawings, wherein like reference numbers refer to like components, and beginning with FIG. 1, a vibration welding system 10 is configured for forming a weld using ultrasonic vibrations or vibrations of other suitable frequencies. The welding system 10 may include welding control equipment 12 including a power supply 14 operable for transforming an available source power into a form conducive to vibration welding. As is understood by those of ordinary skill in the art, a power supply used in a vibration welding process, such as the power supply 14 shown in FIG. 1, can be electrically-connected to any suitable energy source, e.g., a 50-60 Hz wall socket. The power supply 14 may include a welding controller 16, which is usually but not necessarily integrally included within the power supply.

The power supply 14 and the welding controller 16 ultimately transform source power into a suitable power control signal having a predetermined waveform characteristic(s) suited for use in the vibration welding process, for example a frequency of several Hertz (Hz) to approximately 40 KHz, or much higher frequencies depending on the particular application. The power control signal is transmitted from the power supply 14 or the controller 16 to a converter 18 having the required mechanical structure for producing a mechanical vibration in one or more welding pads 22. The welding pads 22 may be integrally-formed with or connected to a welding horn or sonotrode 24.

The vibration welding system 10 of FIG. 1 may also include a booster 20 which amplifies the amplitude of vibration, and/or changes the direction of an applied clamping force. That is, the mechanical oscillation signal from the controller 16 may initially have relatively low amplitude, e.g., a fraction of a micron up to a few millimeters, which can then be amplified via the booster 20 to produce the required mechanical oscillation. The mechanical oscillation signal is in turn transmitted to the one or more welding pads 22 of the sonotrode 24.

A weld is ultimately formed at or along welding interfaces 26 between any adjacent surfaces of a work piece 28. The welding system 10 may be used to weld or join metals or thermoplastics by varying the orientation of the vibrations emitted by the sonotrode 24. That is, for thermoplastics the vibrations emitted by the sonotrode 24 tend to be perpendicular to the surface being welded, while for metals the direction may be generally tangential thereto.

Still referring to FIG. 1, each welding pad 22 may have a set of knurls 27, i.e., textured surfaces contacting the work piece 28 during formation of a weld at or along the welding interfaces 26. The knurls 27 may be textured or configured as raised teeth and/or other frictional patterns providing a sufficient grip on the work piece 28 when the work piece is clamped. To further facilitate the welding process, work piece 28 is positioned adjacent to a welding anvil assembly 30 having a welder body 32, an anvil body 34 fastened to the welder body, and an anvil head 36 with knurls 38 that are similar in construction to the knurls 27 described above.

A heat source or thermal device 40 is used to heat, via concentrated heat energy (arrows 11), a selected location of a work piece, such as but not limited to the work piece 28, e.g., a selected welding interfaces 26 defined by the interfacing surfaces of the work piece being welded. The selected location can be based on the thickest surface or portion of the work piece 28, the portion of the work piece having the highest thermal conductivity and/or heat capacity, or using other criteria. In one possible embodiment, heat is applied from a location external to the welding interface 26, either prior to or concurrent with the introduction of a vibration to the welding interface. In another embodiment, heat may be applied from within a welding tool, e.g., a portion of the sonotrode 24 and/or the anvil assembly 30. That is, the thermal device 40 may be placed adjacent to the work piece 28, or it may be embedded in structure of one or more welding tools.

The work piece 28 is shown in FIG. 1 as a set of conductive tabs 42 of a multi-cell battery 44, e.g., the type used for electric propulsion of a vehicle (not shown), and a conductive bus bar or interconnecting member 46. The interconnecting member 46 may include side rails 48 connected by a cross member or base 49. In this embodiment, the conductive tabs 42 form electrode extensions of respective battery cells, and are each internally-welded to the various anodes and cathodes comprising that particular cell as will be well understood by those of ordinary skill in the art. The interconnecting member 46 may be constructed of a suitable conductive material, e.g., copper, and may be shaped, sized, and/or otherwise configured to form a rail or bus bar, and mounted to the battery 44. For simplicity, only a portion of the battery 44 is shown in FIG. 1.

Potential uses for the battery 44 include the powering of various onboard electronic devices and propulsion in a hybrid electric vehicle (HEV), an electric vehicle (EV), a plug-in hybrid electric vehicle (PHEV), and the like. By way of example, the battery 44 could be sufficiently sized to provide the necessary voltage for powering an electric vehicle or a hybrid gasoline/electric vehicle, e.g., approximately 300 to 400 volts or another voltage range, depending on the required application.

As the sonotrode 24 of FIG. 1 clamps against the anvil assembly 30 and traps the work piece 28 therebetween, the sonotrode oscillates at a calibrated frequency and amplitude to generate friction and heat at or along welding interfaces 26. However, the anvil assembly 30 acts as a substantial heat sink, and therefore heat is lost as energy is transmitted from the sonotrode 24 toward the anvil assembly. Potentially, the innermost weld, indicated by arrow 33, i.e., the farthest weld spot away from the sonotrode 24, has the lowest temperature, and hence forms the weakest bonding at the corresponding welding interface 26. This effect is counteracted by heating the work piece 28 near that particular welding interface 26 or heating that particular interface directly, as disclosed below, either before or concurrently with formation of the weld.

Referring to FIG. 2, one or more welding tools of the welding system 10 shown in FIG. 2 may be embedded with the thermal device 40 noted above. For example, the anvil body 34 may define a channel 50 in which the thermal device 40 is disposed. In the embodiment shown in FIG. 2, the thermal device 40 is a laser and/or infrared (IR) heating device connected to a power supply, e.g., the power supply 14, via a cable 15, and is configured to direct the concentrated heat energy (arrows 11) toward a target surface 52 of the work piece 28. As shown in FIG. 1, another thermal device 40 may be embedded in the sonotrode 24 to provide additional heating. The welding interface 26 at the innermost weld, as indicated by arrow 33 in FIG. 1, may in some stack ups or work piece configurations be an interface at which additional heating is desirable. The embodiment of FIG. 2 therefore uses a thermal device 40 at least on the anvil side of the work piece 28. Although not shown in FIG. 2 for simplicity, a feedback loop 13 as shown in FIG. 3 may be used to regulate temperature using the thermal device 40 depicted in FIG. 2.

Referring to FIG. 3, in another embodiment the thermal device 40 may be configured as a heat rod and embedded in the anvil head 36 within the channel 50. In this embodiment, the thermal device 40 may include thermocouples 17 connected on one end to a temperature controller 58 within a feedback loop 13. The temperature controller 58 may be part of the welding controller 16 shown in FIG. 1, or it may be a separate control device. The temperature controller 58 is connected to the power supply 14 or to another 110V standard or other suitable power supply, as well as to a higher voltage power supply 62, e.g., a 220V power supply, via a relay 60.

The temperature controller 58 controls the relay 60 as needed to selectively connect and disconnect the thermal device 40 to and from power supply 62 to regulate the temperature generated by the thermal device 40. The anvil body 34 is also shown with the anvil head 36 and knurls 38, as well as with a plurality of mounting holes 56 which receive fasteners (not shown). In this manner, the anvil body 34 may be mounted to the welder body 32 shown in FIG. 1.

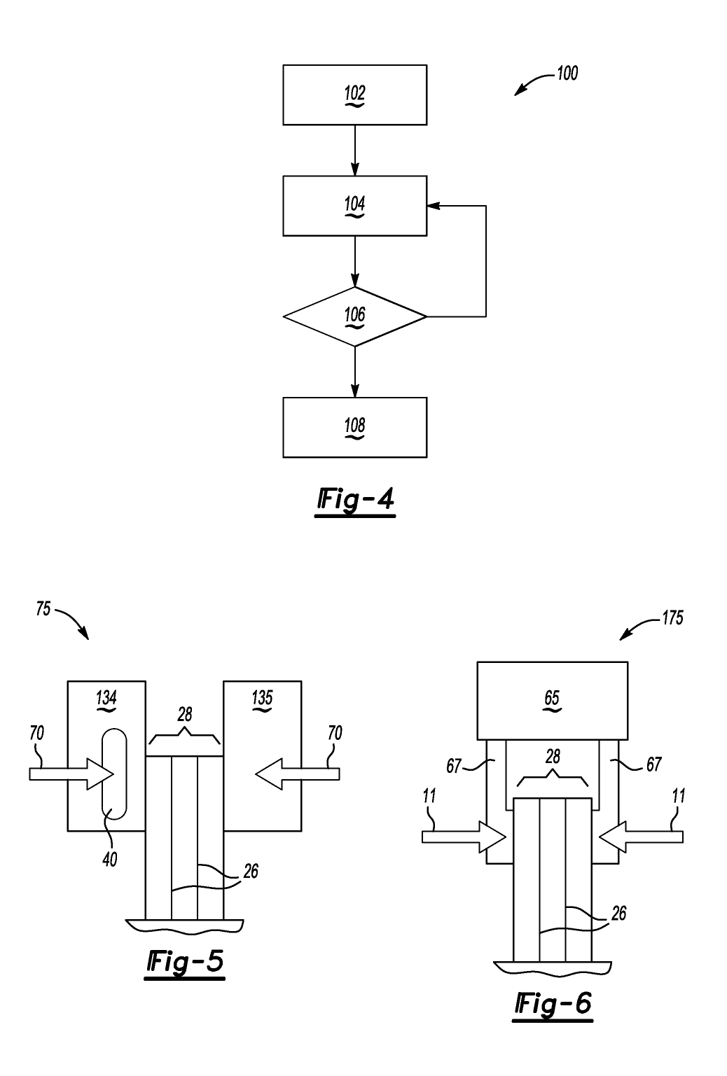

Referring to FIG. 4, a method 100 is shown for heating a work piece 28 and/or a welding interface 26 during a vibration welding process using the welding system 10 shown in FIG. 1. At step 102, the work piece 28 is positioned between the sonotrode 24 and the anvil body 34 to form the welding interface 26. Step 102 in one possible embodiment may include positioning the conductive tabs 42 and the interconnecting member 46 adjacent to each other and between the sonotrode 24 and the anvil body 34, with one of the welding interfaces being the innermost position indicated in FIG. 1 by arrow 33.

At step 104, one or more of the thermal devices 40 are energized to generate heat energy (arrows 11). The heat energy (arrows 11) is directed from with a welding tool, such as the anvil body 34 of FIG. 1, toward and onto the welding interface 26, thereby increasing the temperature of the welding interface before vibrations are transmitted by the sonotrode 24. Alternately, heat energy may be directed toward the welding interface 26 via the thermal device 40 when the thermal device is positioned outside of, i.e., not embedded within, a welding tool, for example a blower or laser device positioned facing the welding interface 26. The method 100 then proceeds to step 106.

At step 106, a designated controller such as the welding controller 16 of FIG. 1 or the temperature controller 58 of FIG. 3 uses a closed-loop feedback control approach, such as the feedback loop 13 shown in FIG. 3, to determine when the temperature of the welding interface 26 reaches a calibrated temperature threshold. The thermocouples 17 may be used to measure the temperature at the welding interface 26, with the measured temperature used by the designated controller in regulating a performance of the thermal device 40 to maintain the temperature within a calibrated range. The sonotrode 24 may be actively vibrating at this point, with the friction heating from the knurls 27, 38 (see FIG. 1) increasing the welding temperature in conjunction with any externally and/or internally applied heat from the thermal device(s) 40. Step 104 is repeated if the sensed temperature is less than the calibrated temperature threshold, with method 100 otherwise proceeding to step 108.

At step 108, the weld is completed. Method 100 may then repeat step 102 for a subsequent weld.

Referring to FIG. 5, a pre-heating assembly 75 may be used to heat a welding interface 26 of work piece 28 in a two-step process. For simplicity, the work piece 28 is shown as three equal components, but the actual size, shape, and/or number of components making up the work piece 28 may vary. For example, the side rails 48 of FIG. 1 may be included in the work piece 28 when welding a battery.

The method 100 of FIG. 4 may be embodied as a two-step process wherein the work piece 28 is pre-heated in one step, and then welded in a subsequent step. In this embodiment, the pre-heating assembly 75 may be any conductive device containing the thermal device 40, e.g., a block of metal, and it may be placed on a station or robot axis separate from any welding tool being used to form the weld, thus facilitating accessibility and independent control. The heating assembly 75 may be formed as a heating block without knurls, which may improve the rate of heat conduction and thus throughput.

For example, a first block 134 may contain the thermal device 40 and may be clamped against a second block 135 lacking the thermal device, with the clamping force indicated in FIG. 5 by arrows 70. Once heated, the blocks 134, 135 may move apart from each other and away from the work piece 28 so that welding of the now heated welding interface 26 may commence.

Referring to FIG. 6, another pre-heating assembly 175 may be embodied as a resistance heating device having a core 65, e.g., a transformer or power supply, and a pair of electrodes 67. The electrodes 67 complete an electrical circuit when clamped to the work piece 28, and thus generate heat via contact or bulk resistance. Preheating temperatures are generally sufficient at the 100°-300° C. level, which may be achieved via the assemblies 75 and 175 disclosed above, as well as by the various thermal devices 40. In the battery embodiment used extensively above, the electrodes 67 may be placed onto the interconnecting member 46 (see FIG. 1), e.g., from two ends or at different locales, thus only heating the interconnecting member.

While the best modes for carrying out the invention have been described in detail, those familiar with the art to which this invention relates will recognize various alternative designs and embodiments for practicing the invention within the scope of the appended claims.

1. A vibration welding method comprising:
positioning a work piece adjacent to a welding tool, wherein the work piece defines a welding interface adjacent to the welding tool;
heating at least one of the work piece and the welding interface to within a calibrated threshold temperature using a thermal device; and
forming a weld using vibrations from a sonotrode after the work piece or welding interface reaches the calibrated threshold temperature.

2. The method of claim 1, including directly heating a portion of the work piece positioned adjacent to the welding interface via the thermal device.

3. The method of claim 1, wherein heating the work piece or the welding interface includes at least one of actively directing heat energy onto the welding interface using the thermal device and heating the welding tool from within using the thermal device.

4. The method of claim 1, wherein positioning the work piece includes positioning a conductive interconnecting member adjacent to a conductive battery tab.

5. The method of claim 1, wherein the thermal device includes one of a laser device, an infrared device, a heat rod, and an electrode.

6. The method of claim 1, wherein the thermal device is embedded within the welding tool and is controlled in a closed feedback loop using a temperature controller and a thermocouple.

7. A vibration welding system comprising:
a welding tool;
a thermal device positioned with respect to the welding tool, and configured for heating a work piece or a welding interface defined by adjacent surfaces of the work piece; and
a controller configured to control an operation of the thermal device to thereby control a welding temperature at or along the welding interface to within a calibrated threshold temperature.

8. The system of claim 7, wherein the thermal device is embedded within the welding tool.

9. The system of claim 8, wherein the thermal device is controlled in a closed feedback loop using the controller and a thermocouple.

10. The system of claim 8, wherein the thermal device includes one of a laser device, an infrared device, a heat rod, and an electrode.

11. The system of claim 8, wherein the work piece includes a conductive interconnecting member and a conductive battery tab of a battery.

12. A vibration welding system comprising:
an anvil head;
a thermal device positioned with respect to the anvil head, and configured for heating a welding interface defined by adjacent surfaces of a work piece being welded by the system; and
a controller configured to control an operation of the thermal device to thereby control a welding temperature at or along the welding interface to within a calibrated threshold temperature.

13. The system of claim 12, wherein the thermal device is embedded within a channel defined by the anvil head.

14. The system of claim 13, wherein the thermal device is controlled in a closed feedback loop, via the controller, using the controller and a thermocouple.

15. The system of claim 13, wherein the thermal device includes one of a laser device, an infrared device, a heat rod, and an electrode.

16. The system of claim 13, wherein the work piece includes a conductive interconnecting member and a conductive battery tab of a battery.
